(19) United States
(12) Patent Application Publication
(10) Pub. No.: US 2006/0010494 A1
(43) Pub. Date: Jan. 12, 2006

(54) Mechanical device for connection and disconnection between a data input and a data output

(76) Inventor: Olivier Emsellem, La Celle-Saint-Cloud (FR)

Correspondence Address: IP GROUP OF DLA PIPER RUDNICK GRAY CARY US LLP, 1650 MARKET ST, SUITE 4900, PHILADELPHIA, PA, 19103, US

(21) Appl. No.: 10/523,946

(22) PCT Filed: Aug. 8, 2002
(86) PCT No.: PCT/FR02/02829

§ 371 Date: Apr. 4, 2005

(51) Int. Cl. G06F 11/00; G06F 11/22; G06F 11/30; G06F 11/32; G06F 11/34; G06F 11/36; G06F 12/14; G06F 12/16; G06F 15/18; G08B 23/00

(52) U.S. Cl. 726/23

(57) ABSTRACT

A mechanical connection and disconnection device between an information input in an information processing device and an information output of the information processing device including a body positioned exteriorly of the information processing device and composed of a first network of information-conducting wires at one end portion and a second network of information-conducting wires at another end portion; and, optionally, an intermediary part comprising a third network of segments of information-conducting wires wherein the intermediary part can be 1) in an ON position such that the segments are in an extension of the conductive wires of the first and second networks of information-conductive wires thereby enabling circulation by contact of the information and 2) in an OFF position in a manner such that the segments are not in the extension of the information-conducting wires of at least one network of information-conducting wires, thereby cutting off circulation of the information.

The present invention pertains to a mechanical connection and disconnection device between a computer output and a peripheral device, more specifically a modem.

Computers are currently connected in networks that are internal or external to the enterprise. The security of the computers is a problem that increases with the increasing number of computers. Personal or enterprise users must deal with the risk of hacking which consists of entering into the computer's programs and of destroying, modifying, stealing or spying on the data. This risk is further increased by the use of uninterrupted high-speed connections as in the case of high-speed modems.

Currently computer devices comprise security devices which are antiviral programs and barriers between the computer or the computer network and an Internet link, these barriers being called firewalls. Firewalls can be electronic packages assigned to protect the enterprise network from unauthorized external or internal intrusion. These firewalls are very powerful and can control groups of multiple hundreds of computers but they are very expensive and complicated to use. Only highly qualified personnel can manage the numerous parameters of these firewalls. However, attacks from the exterior are successful in most cases because the firewalls are poorly configured.

Firewall and antivirus programs exist which can be installed on each computer. But the firewalls are difficult to parameterize by an unspecialized individual. Moreover, the antivirus programs must be regularly updated.

The final and most radical solution for protecting a computer of a local network or LAN (Local Area Network) and/or the Internet, is to physically disconnect or isolate said computer from said network. On the same principle, a local network or LAN and/or other external networks WAN (Wide Area Network). Upon detection of the presence of a virus on a computer of a computer center or LAN, the administrator in charge of network security will first ask the user of the machine involved to disconnect it from the network or the administrator himself will perform that operation. The ultimate means of protection is thus the physical disconnection of the computer, i.e., the unplugging of the cable that connects it to the network and/or switching off the computer.

Connecting then disconnecting and then reconnecting a cable is not an operation that is difficult in itself but it involves manual operations which cause a loss of time. The goal of the present invention is to obtain a physical disconnection without unplugging the cable that connects the computer to the network. This goal is achieved by positioning a 100% mechanical switch between the network and the computer.

Document WO-A2-01/95069 describes a data interruption device that comprises an input orifice, an output orifice and a connector between the output and the input. The connector can be open or closed by a switch which can be actuated by a button. The switch is turned on by a button and it is active according to the data provided by a processor. The switch thus comprises computer-based parts and in no case is it suggested in this description that the switch is 100% mechanical. Moreover, the switch can be configured in the OFF position while the connection remains open (see page 7, lines 16 to 22 of the description of WO-A2-01/95069). This device is configurable and thus requires extensive manual operations.

For this purpose, the invention pertains to a mechanical connection and disconnection device between an information input and an information output, characterized in that it comprises a body composed of a first network of information-conducting wires at one of its ends and a second network of information-conducting wires at the other of its ends, an intermediary part composed of segments of information-conducting wires, said intermediary part can be in an ON position such that said segments are in the extension of said conductive wires of the first and second networks of information-conductive wires thereby enabling the circulation of information and can be in an OFF position in a manner such that said segments are not in the extension of said information-conducting wires of at least one network of information-conducting wires, thereby cutting off the circulation of information.

According to the invention, the intermediary part is displaced from an ON position to an OFF position by means of a pushbutton which swings said intermediary part around its median transverse axis.

The intermediary part can be displaced from an ON position to an OFF position by means of a lever button which causes displacement of said intermediary part from its first position in the extension of said conductive wires to a position essentially parallel to the first position.

The intermediary part can be displaced from an ON position to an OFF position by means of a pushbutton which can swing said intermediary part around its transverse axis located at the end of the intermediary part.

The body can be composed of a first part composed at one of its ends by said first network of wires and a second part composed at one of its ends of said second wire network, said first part and said second part interlocking with each other in a manner such that the end of the first part and the end of the second part form the ends of the body.

Said second part and said first part are made to interlock with each other by force interlocking.

Said second part has a semicylindrical recess which can receive the transverse rotation axis of said intermediary part to enable the pivoting of this part around this axis between an ON position according to which the ends of the intermediary part come into contact with the first and the second network of wires and an OFF position according to which the two ends of the intermediary part are not in contact with the first and the second network of wires.

The information-conducting wires can be copper wires.

The information-conducting wires can be optical fibers.

Said information can be data originating from a computer.

Said information can be data transmitted to a computer or a processor controlling a device.

Said device can be a household appliance.

The device according to the invention can be applied to computer-based activities, robotics, home automation, connectics and network operations, etc.

The present invention moreover pertains to a connection and disconnection procedure between an information input and an information output, such that there is introduced between the information input and the information output a connection and disconnection device comprising solely mechanical means to the exclusion of any computer-based means.

The description below with reference to the attached drawings as nonlimitative examples will provide better understanding of how the present invention can be implemented in practice.

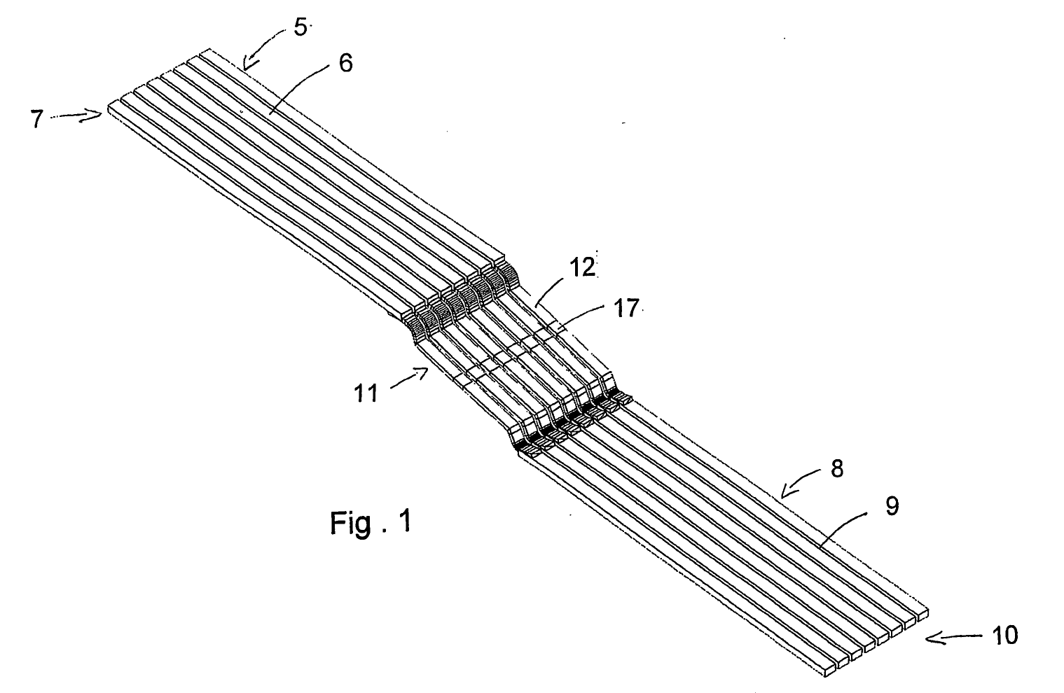

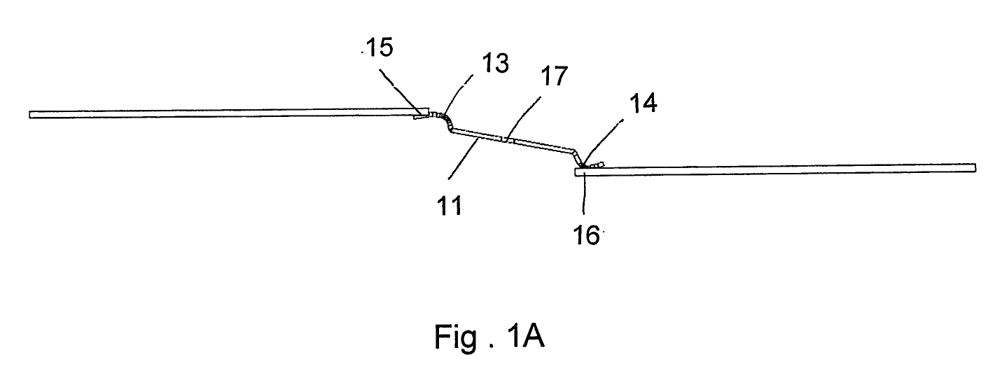

FIG. 1 is a schematic view of a part of one mode of implementation of the device according to the present invention in ON position;

FIG. 1A is an enlarged view of the connection according to FIG. 1;

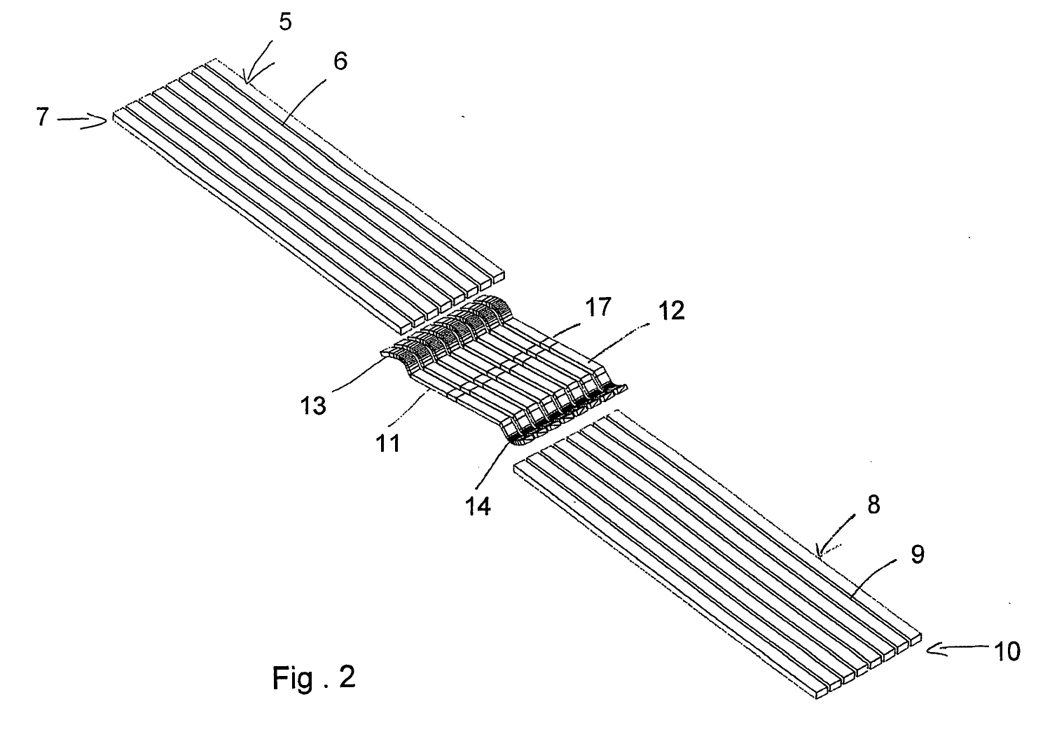

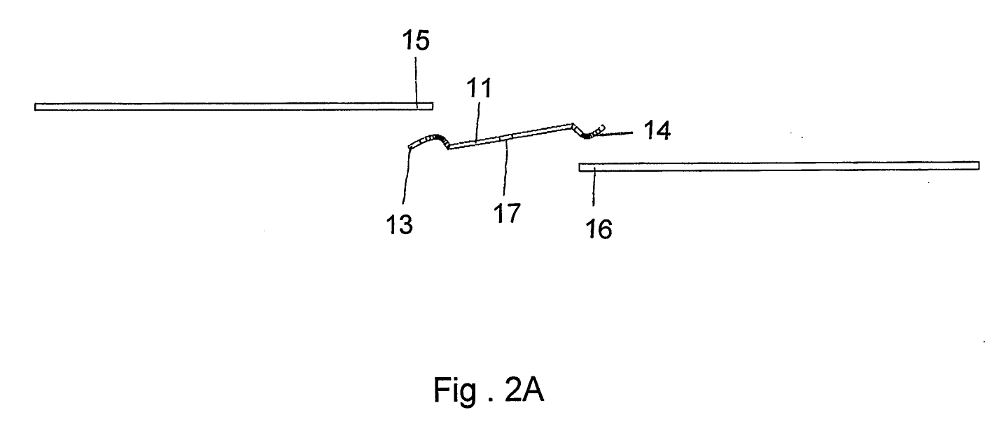

FIG. 2 is a schematic view of a part of another mode of implementation of the device according to the present invention in OFF position;

FIG. 2A is an enlarged view of the connection according to FIG. 2;

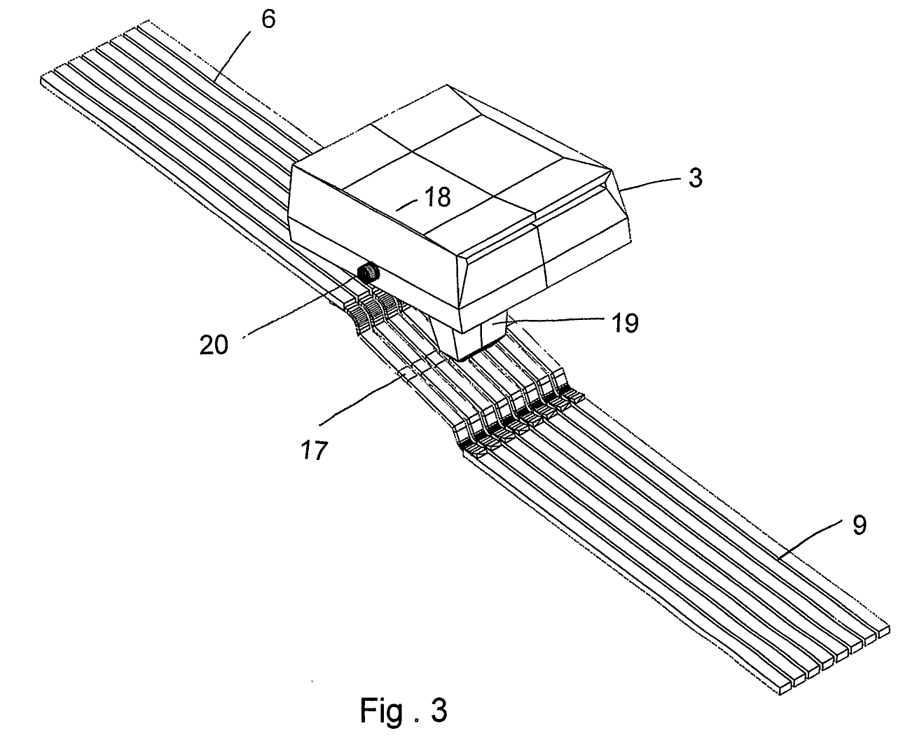

FIG. 3 is a schematic view of the device according to FIG. 1 with the button allowing the intermediary part to swing, in ON position;

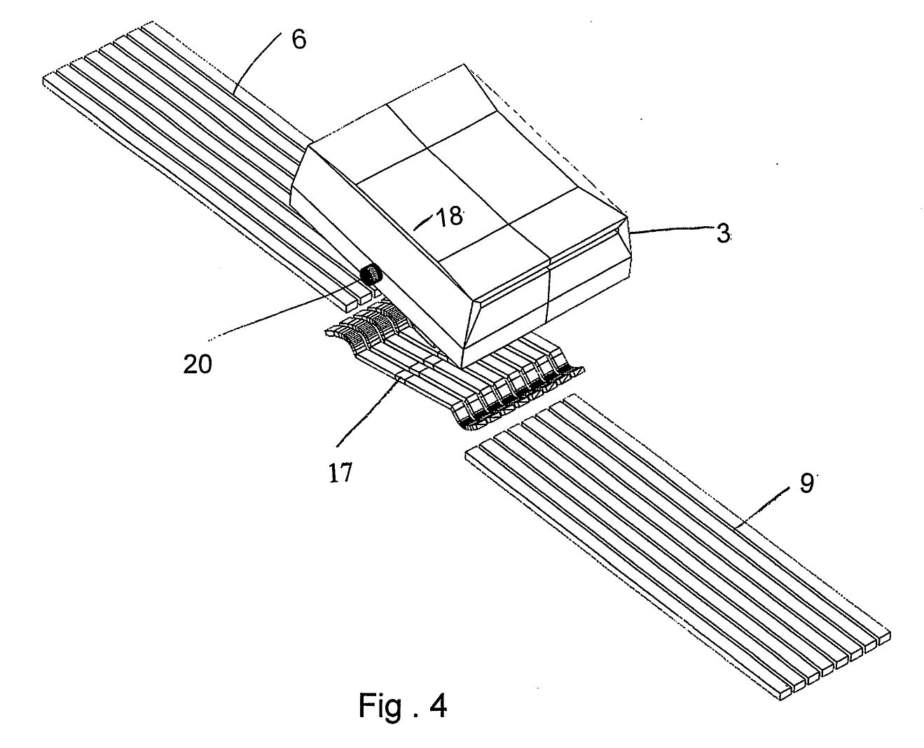

FIG. 4 is a schematic view of the device according to FIG. 2 with the button allowing the intermediary part to swing, in OFF position;

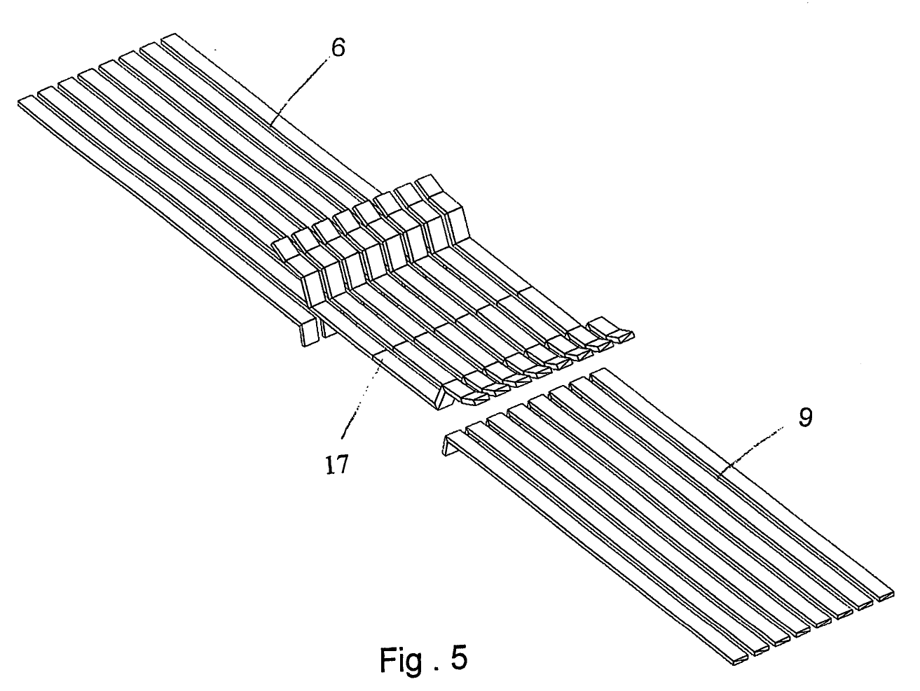

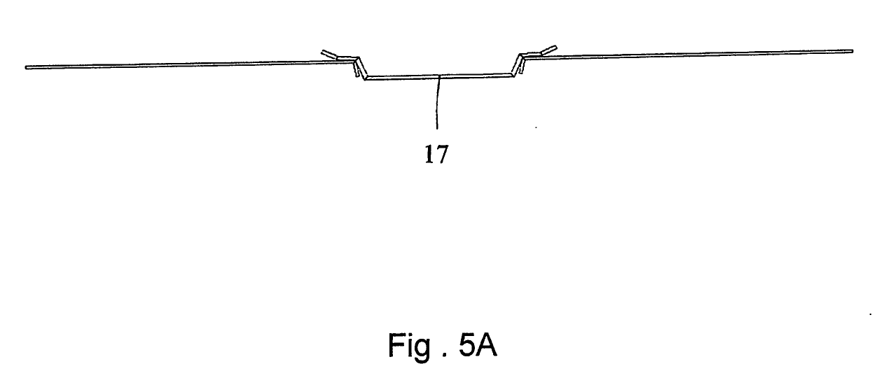

FIG. 5 is a schematic view of a part of another mode of implementation of the device according to the present invention in ON position;

FIG. 5A is an enlarged view of the connection according to FIG. 5;

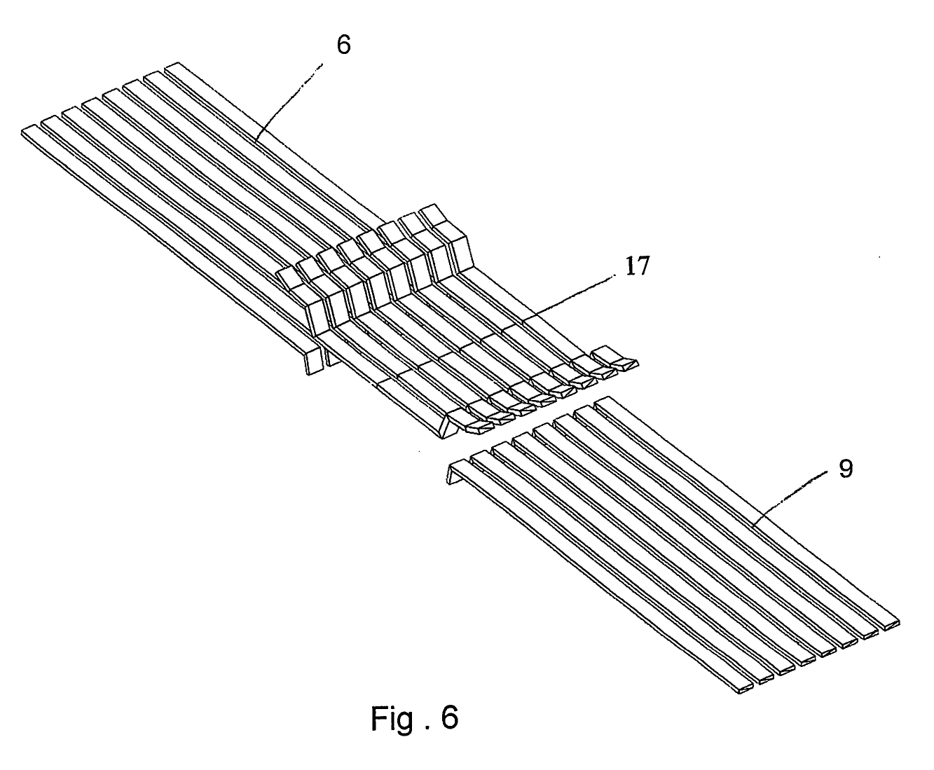

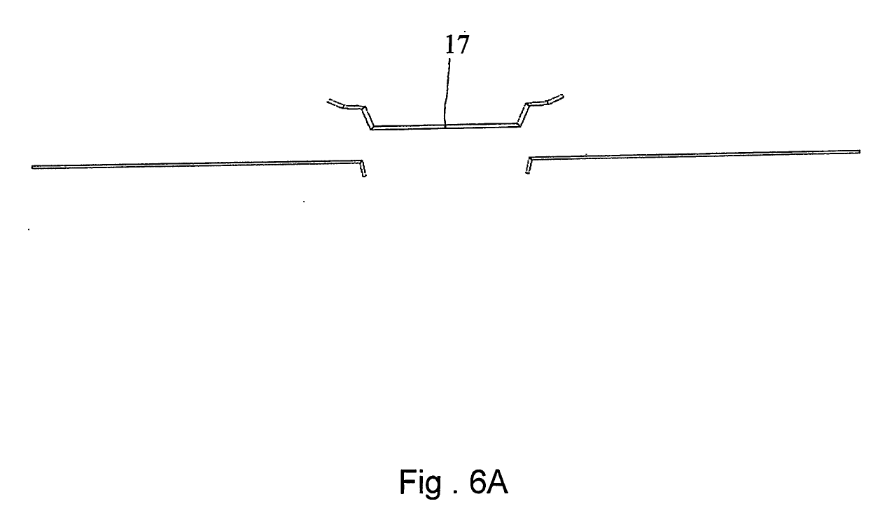

FIG. 6 is a schematic view of a part of another mode of implementation of the device according to the present invention in OFF position;

FIG. 6A is an enlarged view of the connection according to FIG. 6;

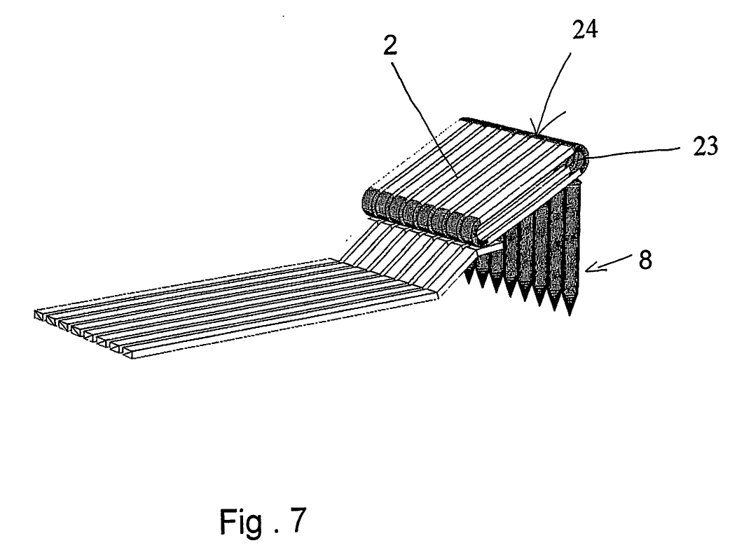

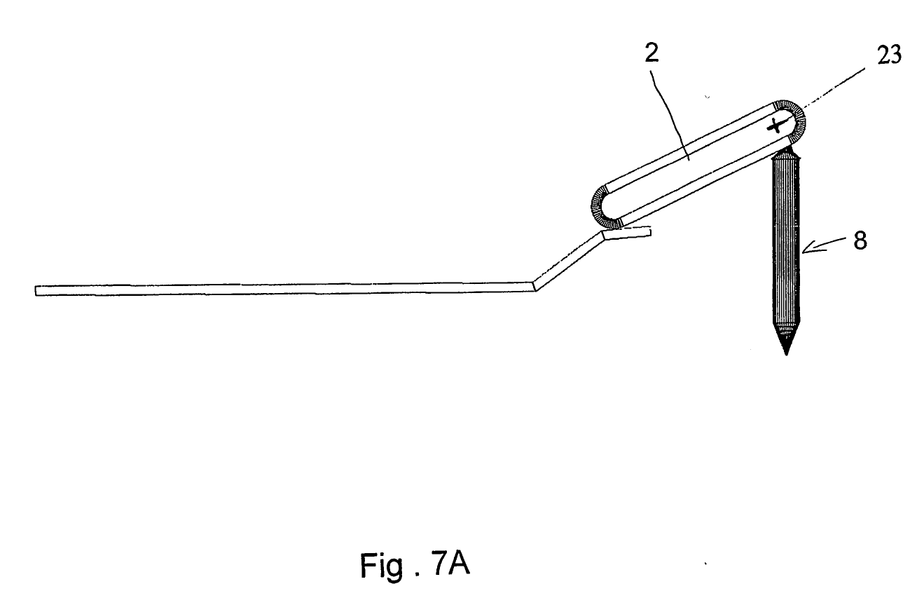

FIG. 7 is a schematic view of a part of still another mode of implementation of the device according to the present invention in ON position;

FIG. 7A is an enlarged view of the connection according to FIG. 7;

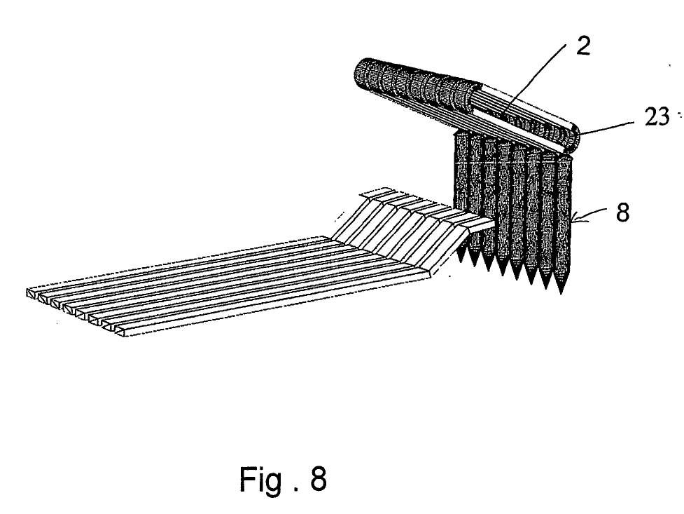

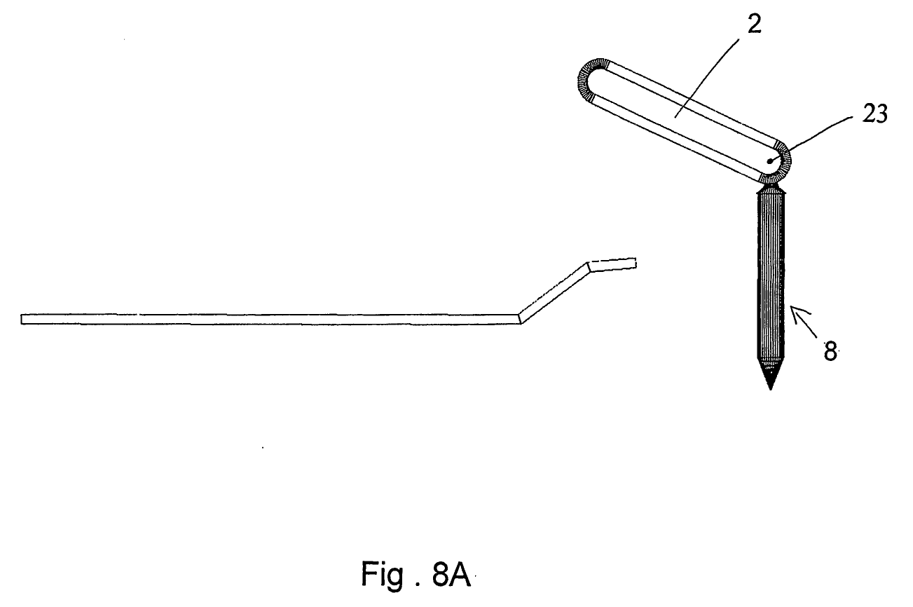

FIG. 8 is a schematic view of a part of another mode of implementation of the device according to the present invention in OFF position;

FIG. 8A is an enlarged view of the connection according to FIG. 8;

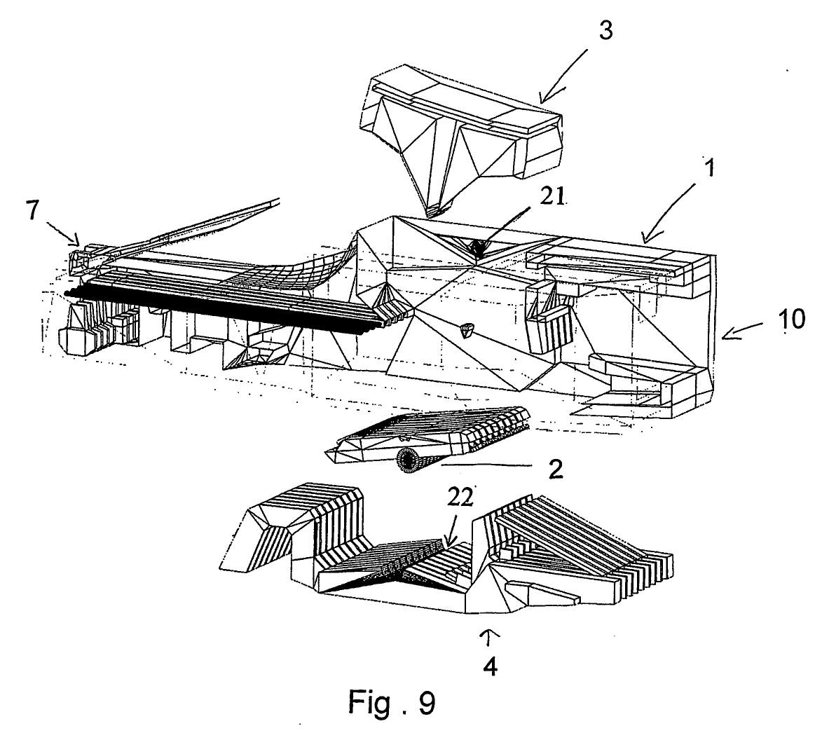

FIG. 9 is an exploded view of the mode of implementation according to FIG. 1.

As can be seen most particularly in FIG. 9, the device according to the present invention comprises a part 1 which forms its body, an intermediary part 2 and a button actuating the intermediary part 2. The intermediary part 2 and the body 1 are made to interlock by means of an interlocking part 4, e.g., by clipping of the interlocking part 4 with the intermediary part 2 and the body part 1. It is also possible to provide a different interlocking of parts 2 and 3. The button 3 is held in place by pins 20 that engage in the holes 21 provided in the body 1.

The body 1 comprises a first network 5 of conductive wires 6 at one of its ends 7 and comprises a second network 8 of conductive wires 9 at its opposite end 10. It is possible to provide 2, 4, 6, 8 or 10 conductive wires. These conductive wires can, e.g., be made of copper or optical fibers or any other longitudinal wire enabling the circulation of information and/or data. As can be seen most particularly in FIG. 1, the first network 5 of wires 6 and the second network 7 of wires 8 are each in the extension but are distant from each other. They are separated by a third network 11 of segments of conductive wires 12. The segments of conductive wires 12 have a point network at one end 13 and a point network 14 at their opposite end. The point network 13 and the point network 14 come into contact with the points 15 of the first network 5 of wires 6 and the points 16 of the second network 8 of wires 9, as can be seen in FIG. 1A. The device is then in ON position, i.e., information can be transported by the first network 5, then by the third intermediary network 11 and then by the second network 8. The information is then transmitted. The wires can be made of copper or other conductive metal or can be optical fibers, and in general any material enabling transport of information via wire.

As can be seen in FIG. 2, when the third network 11 of segments of conductive wires 12 is such that the network of points 13 and the network of points 14 are not in contact with the points 15 of the first network 5 of wires 6 nor with the points 16 of the second network 8 of wires 9. The device is then in OFF position. The circulation of information via the first network 5 is interrupted by the third intermediary network 11. This interruption of circulation of information is due to the fact that the intermediary piece was moved in rotation around its medial axis 17 by the button 3.

As can be seen more precisely in FIGS. 3 and 4, the button 3 has a surface 18 having the form of a parallelepiped, a foot 19 and two pins 20. The foot 19 interlocks with the surface 18 and rests on the intermediary part 2. When action is performed on the surface 18 of the button 3, the foot 19 is displaced and causes the pivoting of the intermediary part 2 around its medial transverse axis 17. The interlocking part or second part 4 comprises a semicylindrical recess 22 that can receive the transverse axis of rotation of the intermediary part 2.

Another mode of implementation of the present invention has been represented in FIGS. 5 and 6. According to this mode of implementation, the intermediary part is displaced but not in rotation around its medial axis 17 but rather in translation. In ON position, the medial axis 17 is essentially in the same plane as the plane of the first and second networks 5, 8. In OFF position, the medial axis 17 is in a plane different from that of the first and second networks 5, 9, preferably a plane superior to that of the first and second networks.

Still another mode of implementation of the present invention is represented in FIGS. 7 and 8. According to this mode of implementation, the intermediary part 2 is mobile in rotation around a transverse axis 23 located at the end of the end 24 of the intermediary part 2 closest to the second network 8 of conductive wires.

According to one mode of implementation of the present invention, the wires are made of copper. It is also possible to use optical fibers in place of these wires.

The various elements of the device according to the invention, with the exception of the wires, are made of a plastic material, e.g., a polycarbonate, polypropylene and polyethylene. This material must enable the clipping together of the parts 1, 2 and 4.

The device can include an LED (Light Emitting Diode), i.e., an electroluminescent electrode, which indicates whether the device is in the open or closed position.

According to another mode of implementation of the present invention, the intermediary part can be locked in ON or OFF position by means of a mechanical locking device. In this manner, any unauthorized person is prevented from actuating the button.

The invention was described here with regard to three preferred modes of implementation. But it is understood that the expert in the field could implement modifications of these modes of implementation without thereby going beyond the scope of the present invention which is defined by the attached claims.

1-11. (canceled)

12. A method for physically connecting and disconnecting an information input and an information output comprising:
introducing between the information input and the information output a connection and disconnection device comprising solely mechanical structures to the exclusion of any computer-based means; and
activating the connection and disconnection device to physically connect or disconnect the information input and the information output.

13. A mechanical connection and disconnection device between an information input in an information processing device and an information output of the information processing device comprising:
a body positioned exteriorly of the information processing device and composed of a first network of information-conducting wires at one end portion and a second network of information-conducting wires at another end portion; and
optionally, an intermediary part comprising a third network of segments of information-conducting wires wherein the intermediary part can be 1) in an ON position such that the segments are in an extension of the conductive wires of the first and second networks of information-conductive wires thereby enabling circulation by contact of the information and 2) in an OFF position in a manner such that the segments are not in the extension of the information-conducting wires of at least one network of information-conducting wires, thereby cutting off circulation of the information.

14. The mechanical device according to claim 13, wherein the intermediary part is displaced from the ON position to the OFF position with a button which causes the intermediary part to swing around a medial transverse axis thereof.

15. The mechanical device according to claim 13, wherein the intermediary part is displaced from the ON position to the OFF position with a button which causes displacement of the intermediary part from a first position in the extension of the conductive wires to a position essentially parallel to the first position.

16. The mechanical device according to claim 13, wherein the intermediary part is displaced from the ON position to the OFF position with a button which causes the intermediary part to swing around a transverse axis thereof located at an end of the intermediary part.

17. The mechanical device according to claim 12, wherein the body comprises at one end the first network of wires and at an other end the second network of wires, the first and second networks being interlocked in a manner such that the end of the first network and the end of the second network form ends of the body.

18. The mechanical device according to claim 12, wherein the first and second networks are interlocked by force interlocking.

19. The mechanical device according to claim 12, further comprising a second part that was a transverse axis of rotation to allow pivoting of the intermediary part around the transverse axis between the ON position according to which two ends of the intermediary part come into contact with the first and the second network of wires, and the OFF position according to which two ends of the intermediary part are not in contact with the first and the second network of wires.

20. The mechanical device according to claim 12, wherein the information-conducting wires are metal wires.

21. The mechanical device according to claim 12, wherein the information is comprised of data originating from a computer or a processor which are transmitted to a computer or to a processor controlling a device.

22. The mechanical device according to claim 18, wherein the intermediary part can be locked in ON position or in OFF position with a mechanical locking device.

23. A mechanical connection and disconnection device between an information input in an information processing device and an information output of the information processing device comprising:
a body positioned exteriorly of the information processing device and composed of a first network of information-conducting wires at one end portion and a second network of information-conducting wires at another end portion; and
an intermediary part comprising a third network of segments of information-conducting wires wherein the intermediary part can be 1) in an ON position such that the segments are in an extension of the conductive wires of the first and second networks of information-conductive wires thereby enabling circulation by contact of the information and 2) in an OFF position in a manner such that the segments are not in the extension of the information-conducting wires of at least one network of information-conducting wires, thereby cutting off circulation of the information.
